(19) United States
(12) Patent Application Publication
(10) Pub. No.: US 2012/0289094 A1
(43) Pub. Date: Nov. 15, 2012

(54) CONNECTOR ASSEMBLY

(75) Inventors: AN-GANG LIANG, Shenzhen City (CN); LIN DU, Shenzhen City (CN); PING-CHUAN DENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/274,545

(22) Filed: Oct. 17, 2011

(30) Foreign Application Priority Data
May 12, 2011 (CN) 201110122474.X

(51) Int. Cl. H01R 24/28

(52) U.S. Cl. 439/660

(57) ABSTRACT

A connector assembly connecting two electronic components includes a connector and a connection member. The connector is detachably and electrically connected to one electronic component. When the connector is electrically connected to the electronic component, the connection member is detachably and electrically connected between the connector and another electronic component. Thus, the connection between the connector and the connection member is detachable and flexible, and the connector does not need to be disassembled from an electronic device to replace a different lengthed connection members. Thus, the connector can correspondingly match different lengths of connection members, which can improve the versatility of the connector.

### BACKGROUND

1. Technical Field

The disclosure generally relates to mechanical assemblies, and particularly to a connector assembly for electronic components.

2. Description of the Related Art

Connectors are usually used to connect an electronic component such as a hard disk drive to another electronic component such as a motherboard using connection wires. However, the connection between the connector and the connection wire is generally permanent, the connection wire is irreplaceable, and the lengthed the connection wire is unchangeable. Thus, the connectors with different lengthed connection wires are used to match corresponding electronic components, which may increase manufacturing cost and reduce versatility of the connectors.

Therefore, there is room for improvement within the art.

### BRIEF DESCRIPTION OF THE DRAWINGS

Many aspects of a connector assembly can be better understood with reference to the following drawings. The components in the drawings are not necessarily drawn to scale, the emphasis instead being placed upon clearly illustrating the principles of the connector assembly. Moreover, in the drawings, like reference numerals designate corresponding parts throughout the several views. Wherever possible, the same reference numbers are used throughout the drawings to refer to the same or like elements of an embodiment.

FIG. 1 is a schematic and exploded view of a connector assembly, according to an embodiment of the disclosure.

FIG. 2 is similar to FIG. 1, but shown from another angle.

FIG. 3 is a schematic assembled view of the connector assembly connected to two electronic components of the disclosure.

### DETAILED DESCRIPTION

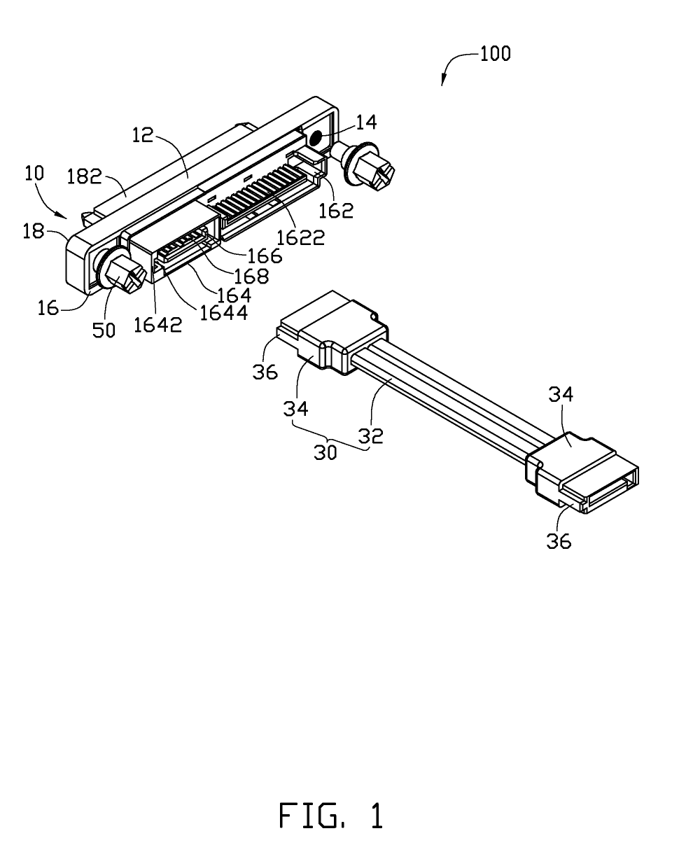

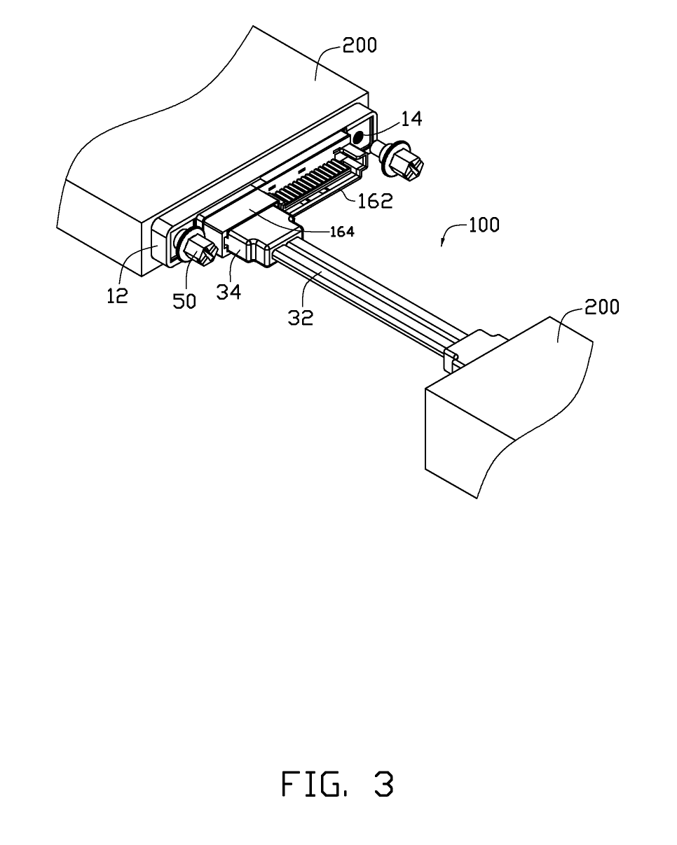

FIG. 1 shows a schematic and exploded view of a connector assembly 100, according to an embodiment of the disclosure. The connector assembly 100 can be an electro-mechanical device to join electrical circuits as an interface using a mechanical assembly. In this embodiment, the connector assembly 100 connects two electronic components 200 (shown in FIG. 3), such as a hard disk drive (HDD) and a motherboard, a power supply unit or the like. The HDD and the motherboard are taken here as examples of electronic components 200.

The connector assembly 100 is detachably connected to the backplate of an electronic device (not shown), such as a computer, and the HDD and the motherboard are assembled inside the housing of the electronic device and electrically connected to each other through the connector assembly 100. In this embodiment, the connector assembly 100 includes a connector 10, a connection member 30, and two fixing members 50.

In this embodiment, the connector 10 includes a main body 12, and the main body 12 is substantially rectangular shape and is made of insulating material. The main body 12 includes a first surface 16 and a second surface 18 opposite to the first surface 16. The main body 12 further defines two fixing holes 14 located at opposite ends of the main body 12 extending through the first surface 16. The main body 12 further includes a first connection socket 162 and a second connection socket 164 substantially adjacent to the first connection socket 162.

The first connection socket 162 and the second connection socket 164 are located at the first surface 16 and between the two fixing holes 14. The first connection socket 162 is substantially adjacent to one of the fixing holes 14 and includes a plurality of conductive pins 1622. In this embodiment, the number of the conductive pins 1622 is fifteen, which can electrically connect a power supply of the electronic device to provide operating voltage for the electronic component 200 such as a HDD, for example.

The second connection socket 164 is substantially adjacent to the other fixing hole 14 and includes a frame 1642, a base body 166, and a plurality of conductive pins 168. The frame 1642 forms a receiving space surrounded by its sidewalls and defines a guiding slot 1644 at one sidewall. The base body 166 is received within the receiving space of the frame 1642, and the plurality of conductive pins 168 are positioned on the base body 166. In this embodiment, the number of the conductive pins 168 is seven.

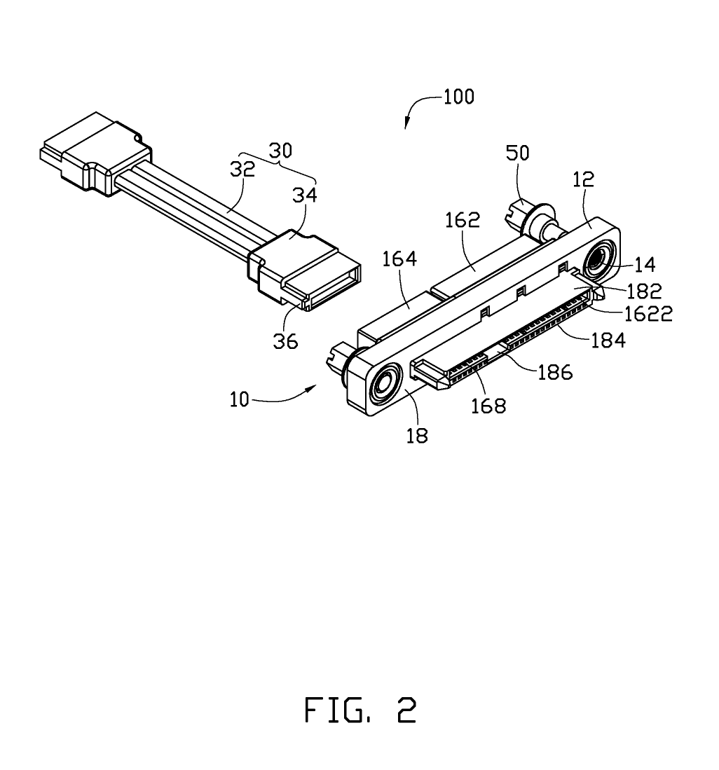

Referring to FIG. 2, the connector 10 further includes a connection port 182 corresponding to the first connection socket 162 and the second connection socket 164. The plurality of conductive pins 1622 and 168 extend through the base body 166 and are received within the connection port 182, so the connection port 182 shares the plurality of conductive pins 1622 with the first connection socket 162, and shares the plurality of conductive pins 168 with the second connection socket 164. The connection port 182 includes a bottom wall 184 and an opening 186 on the bottom wall 184. The opening 186 is located between the plurality of conductive pins 1622 and 168 to separate the conductive pins 1622 from the conductive pins 168, so the connection port 182 is divided into two different types of sub-connection ports corresponding to the conductive pins 1622 and the conductive pins 168. Thus, the sub-connection ports of the connection port 182 are respectively compatible with a serial advanced technology attachment (SATA) interface and a serial attached SCSI (SAS) of the HDD.

The connection member 30 electrically connects the connector 10 to the electronic component 200 (e.g., the motherboard), and includes a transmission cable 32 and two connector interfaces 34 electrically connected to opposite ends of the transmission cable 32. The transmission cable 32 carries and transmits data between the HDD and the motherboard. One of the connector interfaces 34 is electrically and detachably connected to the motherboard; the other connector interface 34 is detachably received within the second connection socket 164 and is electrically connected to the conductive pins 168 of the second connection socket 164.

In this embodiment, each connector interface 34 includes a projection 36 protruding from the side surface of the connector interface 34. The projections 36 is aligned with the guiding slot 1644 of the second connection socket 164, and is detachably received within the guiding slot 1644 to secure and assemble the connector interface 34 to the second connection socket 164. Since the connection member 30 can be detachably connected to the second connection socket 164, so the connector 10 does not need to be disassembled from the electronic component 200, but by means of replacing or using other appropriately lengthed connection members 30. Thus, the connector 10 can correspondingly match different lengthed connection members 30, improving the versatility of the connector 10.

In this embodiment, the fixing members 50 can be screws or bolts. Each fixing member 50 matches and is received within the corresponding fixing hole 14 of the main body 12 to fasten and secure the connector 10 to the electronic device. Thus, when the connection member 30 needs to be replaced, there is no need to disassemble the connector 10 from the electronic device.

Referring to FIG. 3, in use, any of the connector interfaces 34 of the connection member 30 is electrically and detachably connected to the second connection socket 164, the other connector interface 34 is electrically and detachably connected to an electronic component 200, for example, a motherboard. The first connection socket 162 is electrically connected to a power supply of the electronic device to obtain operating voltage for the electronic component 200 such as the HDD for example. The HDD is electrically connected to the connection port 182, enabling the HDD to electrically connect the plurality of conductive pins 1622 and 168. Thus, the HDD can obtain power and communicate with the motherboard.

In summary, in the connector assembly 100 of this disclosure, the connection member 30 is detachably and electrically connected to the connector 10, so the connection between the connector 10 and the connection member 30 is detachable and flexible. Thus, the connector 10 does not need to be disassembled from the electronic device to replace different lengthed connection members 30, therefore, the connector 10 can correspondingly match different lengthed connection members 30, which can improve the versatility of the connector 10.

In the present specification and claims the word “a” or “an” preceding an element does not exclude the presence of a plurality of such elements. Further, the word “comprising” does not exclude the presence of other elements or steps than those listed.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A connector assembly for connecting two electronic components, the connector assembly comprising:
a connector detachably and electrically connected to one electronic component; and
a connection member for carrying and delivering data, wherein when the connector is electrically connected to one electronic component, the connection member is detachably and electrically connected between the other electronic component and the connector.

2. The connector assembly as claimed in claim 1, wherein the connector comprises a main body, and the main body comprises a first surface, a second surface, and two fixing holes, the second surface is located opposite to the first surface, and the two fixing holes are located at opposite ends of the main body and extend through the first surface.

3. The connector assembly as claimed in claim 2, wherein the main body further comprises a first connection socket and a second connection socket, the first connection socket and the second connection socket are located at the first surface and between the fixing holes, the first connection socket is electrically and detachably connected to one of the electronic devices and comprises a plurality of conductive pins.

4. The connector assembly as claimed in claim 3, wherein the second connection socket comprises a frame, a base body, and a plurality of conductive pins, the base body is received in the frame, and the plurality of conductive pin are fixed on the base body.

5. The connector assembly as claimed in claim 4, wherein the connector further comprises a connection port corresponding to the first connection socket and the second connection socket, the conductive pins of the first connection socket and the second connection socket extend through the base body and are received within the connection port, and the connection port share the plurality of conductive pins with the first connection socket and the second connection socket.

6. The connector assembly as claimed in claim 5, wherein the connection port comprises a bottom wall and an opening located at the bottom wall, the opening divides the connection port into two sub-connection ports corresponding the plurality of the conductive pins of the first connection socket and the second connection socket, the two sub-connection ports are respectively electrically connected to a serial attached small computer system interface (SAS) and a serial advanced technology attachment (SATA) interface.

7. The connector assembly as claimed in claim 4, wherein the connection member comprises a transmission cable and two connector interfaces electrically connected to opposite ends of the transmission cable, the transmission cable is capable of carrying and transmitting data between two electronic components, any of the connector interfaces is electrically and detachably connected to an electronic component; the other connector interface is detachably received within the second connection socket and is electrically connected to the second connection socket.

8. The connector assembly as claimed in claim 7, wherein the frame defines a guiding slot located at one sidewall, each connector interface comprises a projection protruding from the side surface of the connector interface, the projections is aligned with the guiding slot of the second connection socket and is detachably received within the guiding slot to secure and assemble the connector interface to the second connection socket, and the connector can correspondingly match different lengthed connection member.

9. The connector assembly as claimed in claim 1, further comprising two fixing members, wherein each fixing member matches and is received within the corresponding fixing hole of the main body to fasten and secure the connector to an electronic device.

10. A connector assembly, comprising:
a connector detachably and electrically connected to one electronic component, the connector comprising:
a connection socket comprising a plurality of conductive pins; and
a connection port located opposite to the connection socket, the connection port sharing the plurality of conductive pins with the connection socket to electrically connected to the electronic component; and
a connection member for delivering data, wherein when the connection port is electrically connected to one electronic component through the plurality of conductive pins, one end of the connection member is detachably and electrically connected to the connection socket through the plurality of conductive pins, the other end of the connection member is electrically connected to another electronic component.

11. The connector assembly as claimed in claim 10, wherein the connector comprises a main body, and the main body comprises a first surface, a second surface, and two fixing holes, the second surface is located opposite to the first surface, and the two fixing holes are located at opposite ends of the main body and extend through the first surface.

12. The connector assembly as claimed in claim 11, wherein the first connection socket and the second connection socket are located at the first surface and between the fixing holes of the main body, the first connection socket is electrically and detachably connected to one of the electronic devices and comprises a plurality of conductive pins.

13. The connector assembly as claimed in claim 12, wherein the second connection socket comprises a frame, a base body, and a plurality of conductive pins, the base body is received in the frame, and the plurality of conductive pin are fixed on the base body.

14. The connector assembly as claimed in claim 13, wherein the connection port corresponds to the first connection socket and the second connection socket, the conductive pins of the first connection socket and the second connection socket extend through the base body and are received within the connection port, and the connection port share the plurality of conductive pins with the first connection socket and the second connection socket.

15. The connector assembly as claimed in claim 14, wherein the connection port comprises a bottom wall and an opening located at the bottom wall, the opening divides the connection port into two sub-connection ports corresponding the plurality of the conductive pins of the first connection socket and the second connection socket, the two sub-connection ports are respectively electrically connected to a serial attached small computer system interface (SAS) and a serial advanced technology attachment (SATA) interface.

16. The connector assembly as claimed in claim 13, wherein the connection member comprises a transmission cable and two connector interfaces electrically connected to opposite ends of the transmission cable, the transmission cable is capable of carrying and transmitting data between two electronic components, any of the connector interfaces is electrically and detachably connected to an electronic component; the other connector interface is detachably received within the second connection socket and is electrically connected to the second connection socket.

17. The connector assembly as claimed in claim 16, wherein the frame defines a guiding slot located at one sidewall, each connector interface comprises a projection protruding from the side surface of the connector interface, the projections is aligned with the guiding slot of the second connection socket and is detachably received within the guiding slot to secure and assemble the connector interface to the second connection socket, and the connector can correspondingly match different lengthed connection member.

18. The connector assembly as claimed in claim 10, further comprising two fixing members, wherein each fixing member matches and is received within the corresponding fixing hole of the main body to fasten and secure the connector to an electronic device.
